(19) United States
(12) Patent Application Publication
(10) Pub. No.: US 2022/0295739 A1
(43) Pub. Date: Sep. 22, 2022

(54) PET CARRIER

(71) Applicant: Sure Loc Pet Carriers LLC, Woodcliff Lake, NJ (US)

(72) Inventor: David YOSKOWITZ, Woodcliff Lake, NJ (US)

(21) Appl. No.: 17/206,444

(22) Filed: Mar. 19, 2021

(51) Int. Cl. A01K 1/02

(52) U.S. Cl. CPC A01K 1/0272

(57) ABSTRACT

A pet carrier for securing and transporting a pet in a vehicle having seat with a lower seat anchor. The pet carrier includes a base, a cover extending upwardly from the base, an entryway formed through the cover, and a handle secured to the carrier. An extendible/retractable rail assembly is fixedly attached to the base of the pet carrier. The rail assembly includes a clamp at a distal rear end of the rail assembly, a securement mechanism and a release mechanism. The clamp is configured to attach and lock onto the lower seat anchor of the vehicle. The clamp is selectively extendible from and retractable into the rail assembly to facilitate attachment and release of the pet carrier to the seat.

### CROSS-REFERENCE TO RELATED APPLICATION

This application claims priority to U.S. provisional application No. 62/991,176, filed Mar. 19, 2020, the content of which is incorporated by reference in its entirety.

### FIELD OF INVENTION

The present application relates to pet accessories and, more specifically, to pet carriers for protecting and transporting a pet.

### BACKGROUND

Many people enjoy the company of pets. When pet owners travel, they often want to bring their pets with them. Small pets, for example, small dogs and cats, are typically transported within hand-held pet carriers. Pet carriers allow a user to safely transport a pet from one location to another. There are many commercially available pet carriers which can be manually secured to a seat of a car by a user with the vehicle's seat belt restraint system. The pet carrier includes an expandable sleeve on an exterior portion of the pet carrier, such that the exterior portion of the pet carrier and the interior portion of the expandable sleeve form an opening therebetween. The expandable sleeve can be made from a fabric or other well-known material and is sized to enable a user to guide the latch and belt or webbing of the vehicle's seat belt restraint system through the sleeve opening. Once the latch and belt are routed through the sleeve opening, the latch is connected to the belt buckle to secure the pet carrier to the seat of the vehicle (e.g., car, SUV, truck, train, aircraft, boat, and the like).

Although the vehicle's seat belt restraint system adequately secures a pet carrier to a rear or front seat of a car, it has been observed that pet carriers which are fabricated from lightweight flexible fabric materials often deform due to the pressure of the seat belt webbing, thereby reducing the available space for the pet in the pet carrier. In addition, the routing of the seat belt through the exterior sleeve of the pet carrier can be cumbersome when trying to insert the latch into the buckle.

A carrier, whether for children or pets that generally employ the LATCH system have certain deficiencies. For a child seat connection, they are either a combination of a base, removably affixed, but generally permanently secured onto which a child seat is engaged and disengaged or provides an engagement which has a connector which, when engaged, creates a space between the connected carrier and the vertical cushion of the seat. In either instance where, for example, use of a non-owned vehicle such as a rental car, taxi, car service, and the like is to be used, the securement of the carrier may be jeopardized due to the undesirable spacing between the carrier and rear seat cushion.

In prior art pet carriers (and child carrier systems) that did not have a pre-installed base on the seat, it is necessary to remove the pet or child from the carrier to permit the installation of the carrier, after which the pet or child is placed on the seat or within the carrier. This is particularly prevalent in cases of use of such carrier when embarking for transit in a non-owned vehicle, where the inability to securely install the carrier with the pet not on or within the carrier is problematic. Therefore, there is a need for an improved pet carrier that can provide adequate protection, comfort, safety and restraint during transportation in a vehicle.

### SUMMARY

The present application is a pet carrier device for securely transporting a pet in a vehicle. The device can include a rigid, semi-rigid, or flexible enclosure configured to safeguard and carry a pet such as, for example, a small dog or cat. The pet carrier includes an entryway for allowing entry and exit of the pet within the carrier device. The pet carrier device includes one or more clamps for connecting or attaching the pet carrier to a child safety seat latch or anchor system in a vehicle. In one embodiment, the clamps are attached to the pet carrier in a foldable or retractable manner. In another embodiment, the clamps are attached to ends of expandable and retractable rail assemblies fixedly attached to the base of the pet carrier.

In particular, in one embodiment, a pet carrier for securing and transporting a pet in a vehicle having seat with a lower seat anchor comprises: a base; at least one wall extending upwardly from the base; a top forming a closed interior enclosure of the carrier; an entryway formed in the at least one wall and/or top; a handle secured to the carrier; a pocket formed in one of the at least one wall and base; and at least one clamp tethered to the carrier, wherein the at least one clamp includes a securement mechanism and a release mechanism, the at least one clamp being configured to attach and lock onto the lower seat anchor of the vehicle, and the at least one clamp is retractable or foldable to be stored in the pocket.

In one aspect, the at least one clamp is tethered via a webbing to the base. In another aspect, the clamp is tethered via a webbing to the at least one wall. In yet another aspect, the securement mechanism of the clamp is configured to attach and lock onto the lower seat anchor of the vehicle.

In another embodiment, a pet carrier for securing and transporting a pet in a vehicle having seat with a lower seat anchor comprises: a base; a cover extending upwardly from the base; an entryway formed through the cover; a handle secured to the carrier; and an extendible/retractable rail assembly fixedly attached to the base of the pet carrier, wherein the rail assembly includes a clamp at a distal rear end of the rail assembly, a securement mechanism and a release mechanism, the clamp being configured to attach and lock onto the lower seat anchor of the vehicle, and the clamp being selectively extendible from and retractable into the rail assembly to facilitate attachment and release of the pet carrier to the seat.

In one aspect, the cover comprises at least one wall attached to a base and a top formed over the at least one wall. In another aspect, the cover includes a flap for selectively opening and closing the entryway. In yet another aspect, the handle is secured to the cover. In still another aspect, the cover includes a mesh material to permit breathing within the carrier.

In one aspect, the rail assembly is fixedly mounted to a bottom surface of the base. In another aspect, the rail assembly includes at least one upwardly extending fastener that extends through the bottom surface of the base. In still another aspect, the upwardly extending fastener is a bolt and nut. In yet another aspect, the rail assembly includes an outer rail and an inner rail, the inner rail being slidably moveable within the outer rail, the clamp being formed at a distal end of the inner rail.

In another aspect, the outer rail includes a longitudinal slot and an actuator is attached to the inner rail through the longitudinal slot. In a further aspect, the inner rail incudes a latch and the outer rail includes a plurality of openings sized to receive the latch, wherein the actuator includes a button configured to control engagement and disengagement of the latch with the plurality of openings in the outer rail, thereby enabling slidable movement of the inner rail with respect to the outer rail. In yet another aspect, the actuator selectively controls opening of the clamp. In another aspect, the clamp includes an upper jaw and lower jaw configured to selectively capture and release the lower seat anchor of the seat. In still a further aspect, the clamp conforms to a LATCH vehicle safety standard.

### BRIEF DESCRIPTION OF THE DRAWINGS

FIG. 1 depicts a first embodiment of a pet carrier including one or more clamps of a LATCH system for securing the pet carrier to a back seat of a vehicle;

FIG. 2 is a side view of the pet carrier of FIG. 1 being restrained to the back seat of the vehicle with the LATCH system;

FIG. 3 is a top, rear perspective view of the pet carrier of FIG. 1 illustrating a pocket or pouch for releasably storing the clamps of the LATCH system within the pet carrier;

FIG. 4 depicts a front elevation view of a second embodiment of a pet carrier including a pair of fixedly attached and extendible rail assemblies each having a clamp;

FIG. 5 is a top, front perspective view of the pet carrier of FIG. 4;

FIG. 6 is a left-side elevation view of the pet carrier of FIG. 4 with a left side covering opened to expose an interior enclosure, the right-side being a mirror image thereof;

FIG. 7 is a rear, left-side perspective view of the pet carrier of FIG. 4 depicting a pair of spaced-apart rail assemblies attached to the bottom of the pet carrier;

FIG. 8 is a front elevation view of the pet carrier of FIG. 4;

FIG. 9 is a left-side, bottom perspective view of the pet carrier of FIG. 4;

FIG. 10 is a bottom view of the pet carrier of FIG. 4;

FIG. 11 is a left-side elevation view of the pet carrier of FIG. 8 with interior padding removed to illustrate a bottom interior portion of the pet carrier;

FIG. 12 is a left-side elevation view of the rail assembly of the pet carrier of FIG. 4 in a partially extended state;

FIG. 13 is a left-side, top perspective view of the rail assembly of the pet carrier of FIG. 4 in a retracted state;

FIG. 14 is a top plan view of the rail assembly of FIG. 13 in the retracted state;

FIG. 15 is a left-side elevation view of the rail assembly of FIG. 13 in the retracted state;

FIG. 16 is a top, rear, left-side perspective view of the rail assembly of the pet carrier of FIG. 4 in a fully extended state;

FIG. 17 is a left-side elevation view of the rail assembly of FIG. 16 in the fully extended state;

FIG. 18 is a schematic view of a portion of the clamp of the rail assembly of the pet carrier of FIG. 4; and

FIG. 19 is a front top perspective view of the pet carrier of FIG. 4 secured on a vehicle seat.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

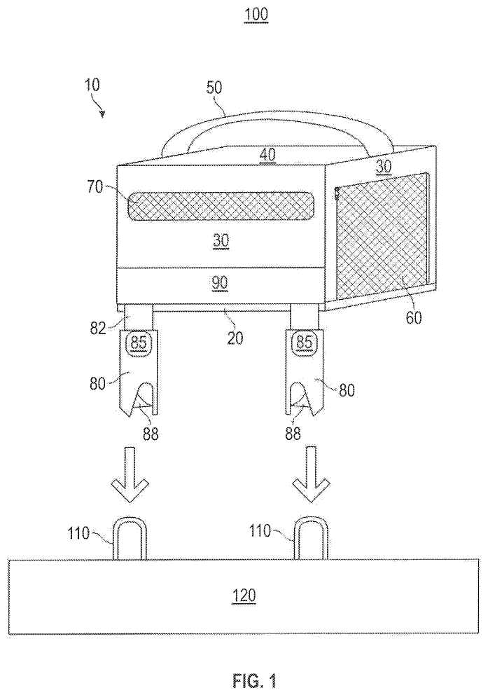

FIG. 1 depicts an illustrative pet carrier arranged in accordance with at least some embodiments described herein. Pet carrier system 100 includes pet carrier 10 and vehicle anchors 110 of a seat 210 of a vehicle 120. The pet carrier 10 includes a base 20, at least one side wall 30, a top 40, a strap/handle 50, an entryway 60, vents 70, clamps 80, and a channel/pocket 90.

The base 20 is preferably formed from a rigid material and be configured to support a pet placed within pet carrier 10. In one embodiment, the base 20 is fabricated from plastic, although such material is not considered limiting. The at least one wall 30 and top 40 form a cover which is sized to protect and store a pet, e.g., small dog, cat and the like, and is fabricated from rigid, semi-rigid, and/or flexible materials to form an enclosure around base 20. The pet carrier 10 shown in FIGS. 1-3 is rectangular in shape, i.e., having four walls, although such shape and quantity of walls is not considered limiting. The walls 30 and top 40 preferably include strong fabrics such as nylon, woven nylon fabric, woven polyester fabric, woven polyethylene fabric, woven polypropylene fabric, poly paraphenylene fabric, terephthalamide, ultra high molecular weight polyethylene, aromatic nylon, aromatic polyester, or combinations thereof. Preferably the exterior walls 30 and top 40 are water resistant. The type of fabrics forming the walls and top 40 are not considered limiting.

At least one of the wall 30 and top 40 includes an entryway 60. The entryway 60 allows entry of a pet within the pet carrier 10. Entryway 60 preferably includes a flap or door which can be manually opened and reclosed to allow entry and exit of a pet. Entryway 60 can be closed and secured by a securement device such as a zipper, clamp, bar, tie, locking mechanism, etc. Entryway 60 can include a solid material, a rigid material, a semi-rigid material, a vented material, a flexible material, bars, a mesh, or combinations thereof.

A strap or handle 50 is preferably attached to pet carrier 10 in any position to facilitate carrying and transport of pet carrier 10 by the user. The strap or handle 50 can include a rigid, semi-rigid, or flexible material and can be strong enough to support weight of pet carrier 10 when a pet is within pet carrier 10 and pet carrier 10 is carried by strap or handle 50.

One or more clamps 80 are attached to pet carrier 10. The clamps 80 are flexibly connected to pet carrier 10 at base 20 or wall 30. In FIG. 1, two clamps 80 are illustratively tethered to the pet carrier 10. One end of the clamp 80 includes a plate which is fixedly attached to the base 20 or wall 30 of the pet carrier 10. In one embodiment, a flexible webbing or strap 82 extends from the plate and is attached to a proximal end of the clamp 80. Alternatively, one end of the webbing 82 is stitched directly to the base 20 or wall 30 and the opposing end is attached to the clamp 80.

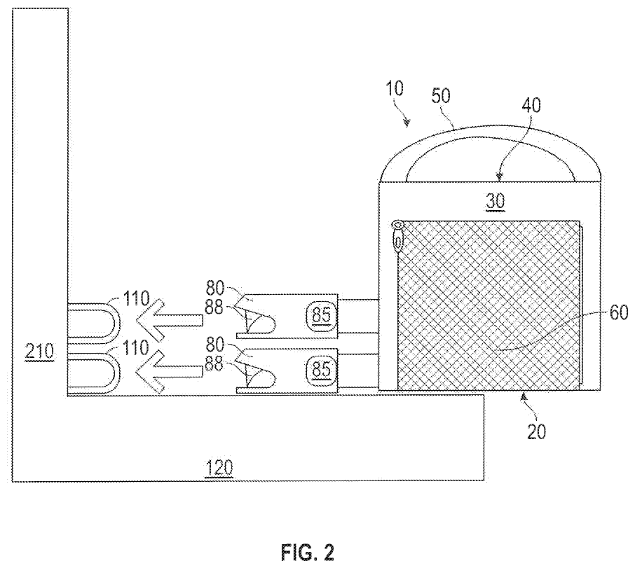

Most vehicles are now being equipped with what are referred to as LATCH (lower anchors and tethers for children) connectors, such as the lower seat anchors 110 and the clamp 80. Each clamp 80 includes a securement mechanism 88 and a release mechanism 85. Securement mechanism 88 is preferably spring loaded and is positioned at a distal end of the clamp. The securement mechanism 88 retracts and engages with a lower seat anchor 110 upon contacting and passing over an outer edge of lower seat anchor 110. The lower seat anchor 110 is a rigid, U-shaped metal rod or wire anchored between the lower and back cushions of the rear seat 210 of the vehicle 120. The securement mechanism 88 is arranged at a distal end of the clamp. The securement mechanism 88 engages and pivots about the lower seat anchor 110 and locks in place to secure the clamp 80 and pet carrier 10 to the lower seat anchor 110. Each clamp 80 can be configured to attach and lock onto a lower seat anchor 110 of vehicle 120. The release mechanism 85 (e.g., button, lever and the like) is preferably positioned at the opposing proximal end of the clamp 80 and unlocks the securement mechanism 88 so that clamp 80 can be unsecured and removed from lower seat anchor 110. The aligning and securing of the pet carrier 10 to the seat anchors 110 is illustrated in FIG. 2. In particular, the rear end of the pet carrier 10 is positioned to face the rear seat cushion 210 and the tethered clamp 80 extends rearwardly towards the seat anchor 110. The user grasps and pulls the clamp 80 rearwardly so that the tethered clamp 80 aligns and automatically engages with the seat anchor 110 in a well-known manner.

Where a pet carrier 10 includes additional clamps, the steps to attach the additional clamps are repeated in the same manner as the attachment of the first clamp 80. The clamps 80 of the pet carrier 10 can be configured to allow easy securement of pet carrier 10 to lower seat anchors 110 of back seat 210 of vehicle 120 when pet carrier 10 is pushed towards lower seat anchors 110 of back seat 210 of vehicle 120. Release mechanisms 85 are manually operated to unlock securement mechanism 88 so that the clamps 80 can be unsecured and removed from lower seat anchors 110, and the pet carrier 10 can be easily removed from the seat 210 of vehicle 120.

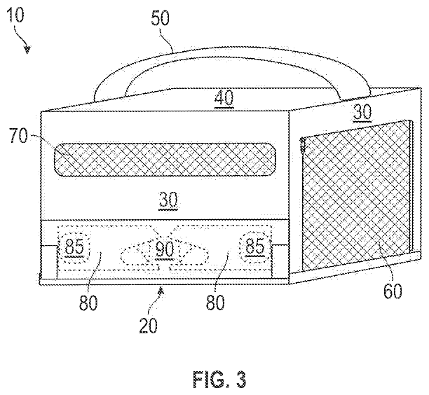

FIG. 3 illustrates an example pet carrier 10 arranged in accordance with at least some embodiments described herein. Those components in FIG. 3 that are labeled identically to components of FIGS. 1 and 2 will not be described again for the purposes of brevity.

When pet carrier 10 is transported by a user with strap or handle 50, clamps 80 can be retractable or foldable so to not stick out from pet carrier 10. As shown in FIG. 3, clamps 80 can retract or fold over and be storable within a channel/pocket 90. Channel/pocket 90 can be a channel or sleeve within wall 30 and/or base 20 which can be configured to hold folded or retracted clamps 80. Channel/pocket 90 can include a flap of material similar to material of wall 30 which can cover over folded or retracted clamps 80 so that clamps 80 are within channel/pocket 90. Flap of channel/pocket 90 can include an attachment mechanism such as VELCRO, buttons, snaps, zipper, etc., so that the flap of channel/pocket 90 can be opened and closed to allow folded or retracted clamps inside and outside of channel/pocket 90.

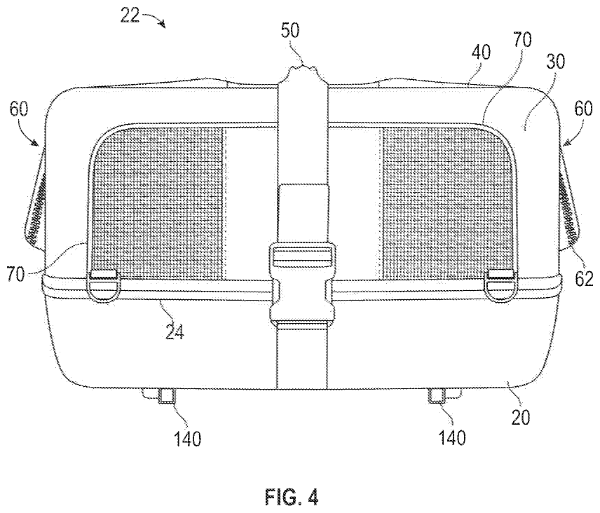

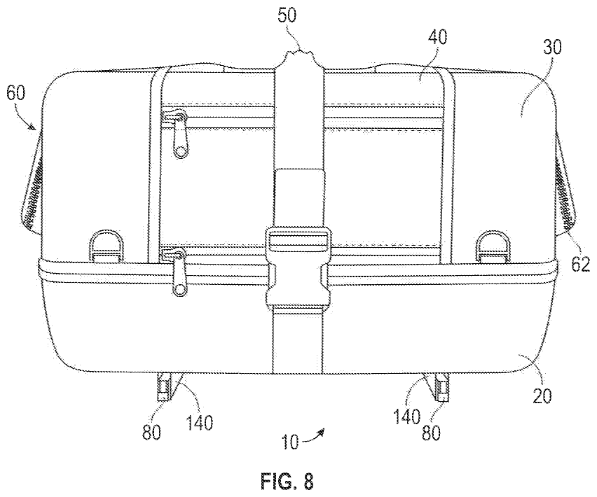

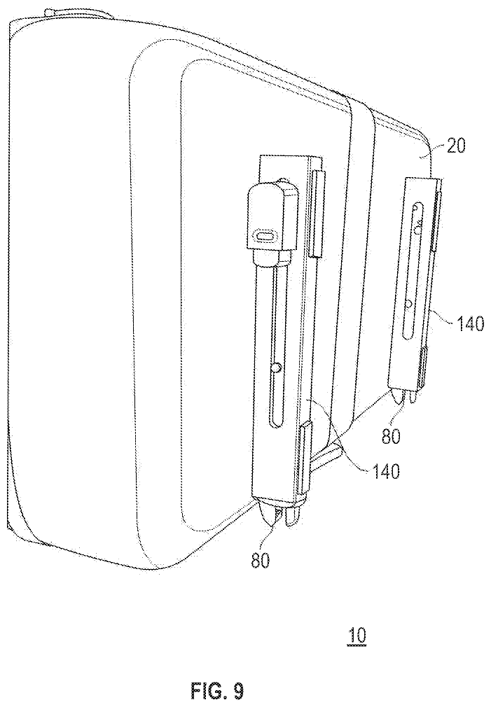

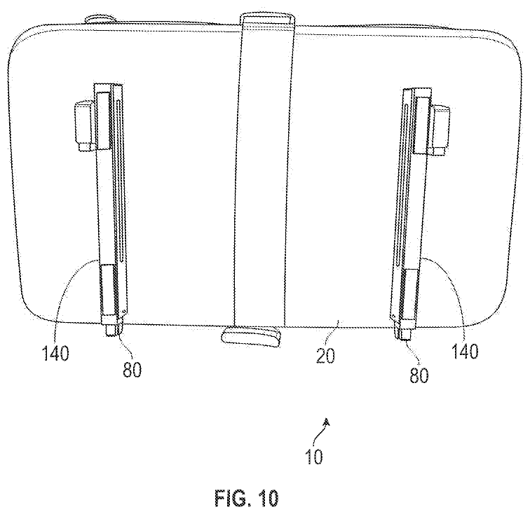

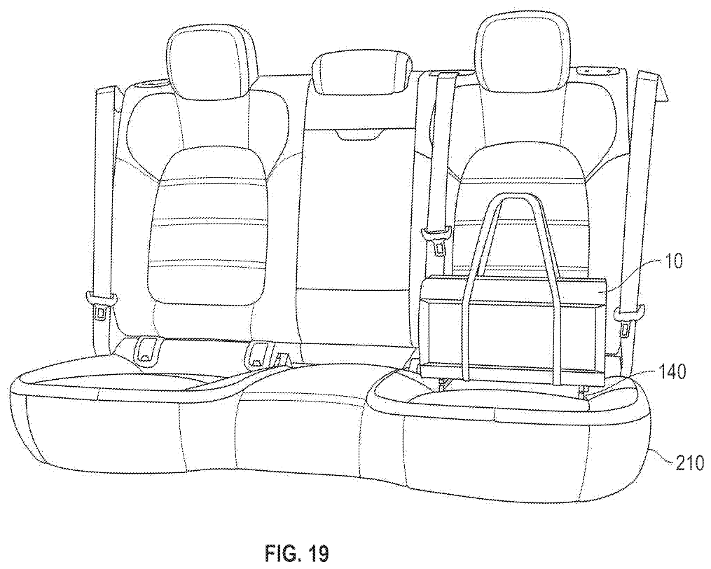

Referring now to FIGS. 4-19, a second embodiment of the pet carrier 10 is illustratively shown. The second embodiment of FIGS. 4-19 differs from the first embodiment of FIGS. 1-3 in that the clamps 80 are fixedly attached to the bottom exterior of the pet carrier via one or more extendable/retractable rail assemblies 140, as opposed to being flexibly tethered to a bottom (base) or rear wall of the pet carrier 10 of FIG. 1.

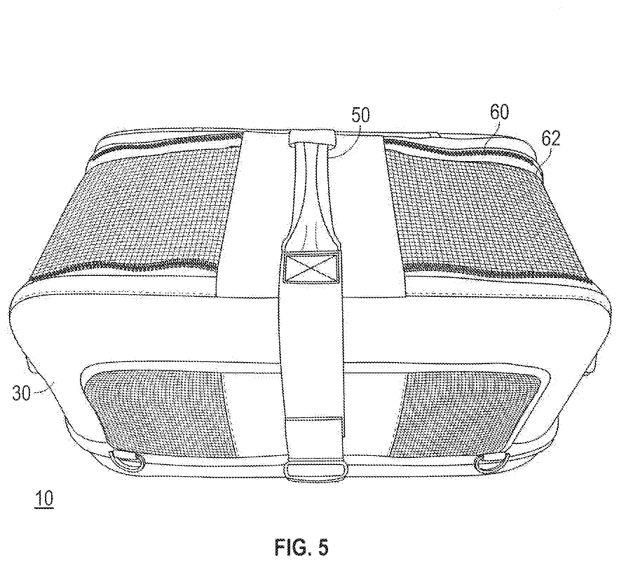

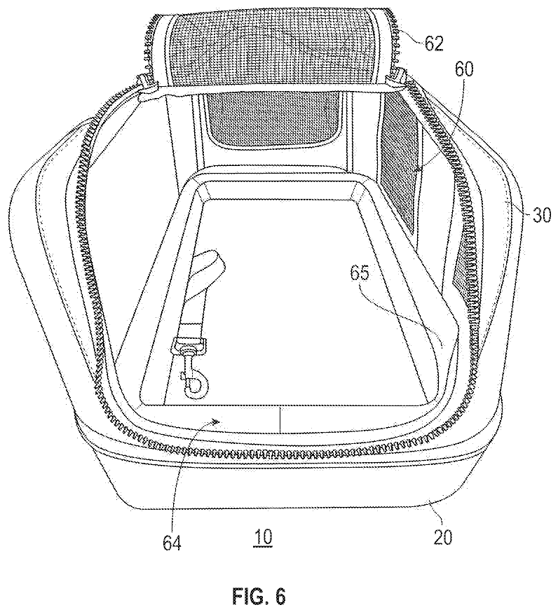

Referring now to FIGS. 4 and 5, the pet carrier 10 includes a base 20 and a cover 22 extending upwardly from the base 20. The cover 22 can be removably attached to the base 20 with fasteners 24 such as a zipper, snaps, latches/clips, among other well-known fasteners. In one embodiment, the cover 22 includes one or more walls 30, a top portion 40, a strap or handle 50, an entryway 60, and vents 70 in a similar manner as described above with respect to FIGS. 1-3, although such arrangement is not considered limiting. Referring to FIG. 6, a left side flap 62 is shown opened to define the entryway 60 in the side wall 30 to thereby permit access to the interior 64 of the pet carrier 10. A cushion 65, pillow or other padded fabric material suitable to provide support and comfort for the pet therein is sized and dimensioned to rest on the interior surface of the base 20. In one embodiment, the cushion 65 floats freely on the interior surface of the base 20. Alternatively, the cushion is secured to an upper surface of the base 20 with a fastener, such as a strap or VELCRO. The flap 62 over the entryway 60 is manually opened and closed, for example, with a zipper, although other fasteners can alternatively be utilized, such as VELCRO straps, laces, buttons, among other well-known fasteners.

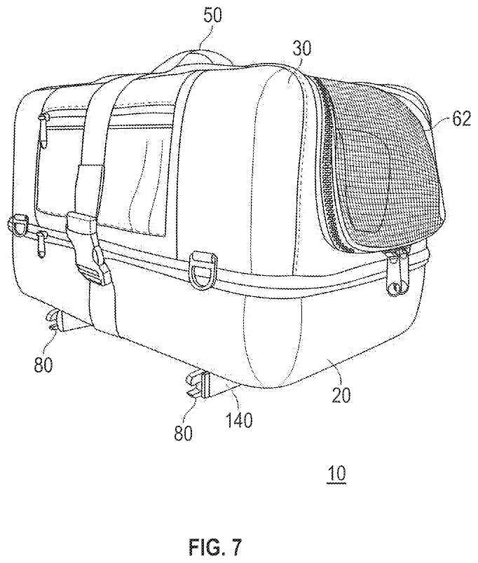

Referring now to FIGS. 7-10, a pair of spaced-apart rail assemblies 140 each having a clamp 80 is fixedly mounted to the bottom surface of the base 20. A person of ordinary skill in the art will appreciate that the number of rail assemblies 140 attached to the pet carrier 10 are not considered limiting.

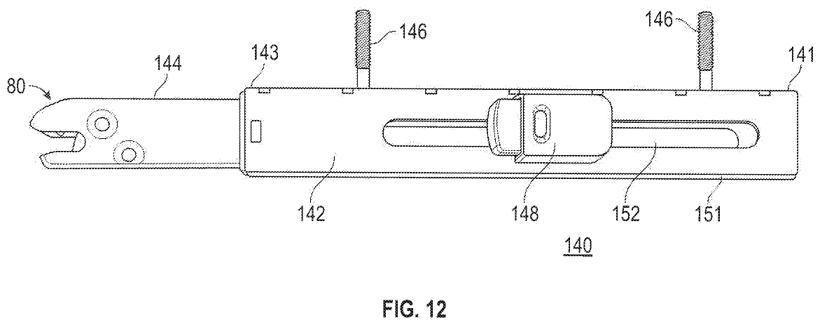

Referring to FIGS. 12-17, an illustrative extendible/retractable rail assembly 140 is illustratively shown. Referring now to FIG. 12, a side elevation view of the rail assembly of FIG. 4 in a partially extended state is depicted. The rail assembly 140 is a “Retracted Isofix Latch” or connector which includes an outer tubular rail 142, an inner rail 144, a clamp mechanism 80 provided at a distal end of the inner rail 144, one or more fasteners 146 for attaching the rail assembly 140 to the base 20 of the pet carrier 10, and an actuator/release mechanism for extending and retracting the inner rail relative 144 to the outer rail 142. The fasteners 146 is illustratively a pair of spaced-apart threaded bolts welded or otherwise fixedly attached to an upper surface of the outer rail 142. The fasteners 146 have a length suitable to extend through the base 20 and into the interior of the pet carrier 10. The extendible clamp 80 is provided at the distal end of the inner rail 144 such that the clamp 80 is extendable from the rear wall 30 or portion of the pet carrier 10 to selectively interface with the seat anchor (i.e., U-shaped wire loops) 110 of the vehicle seat 120.

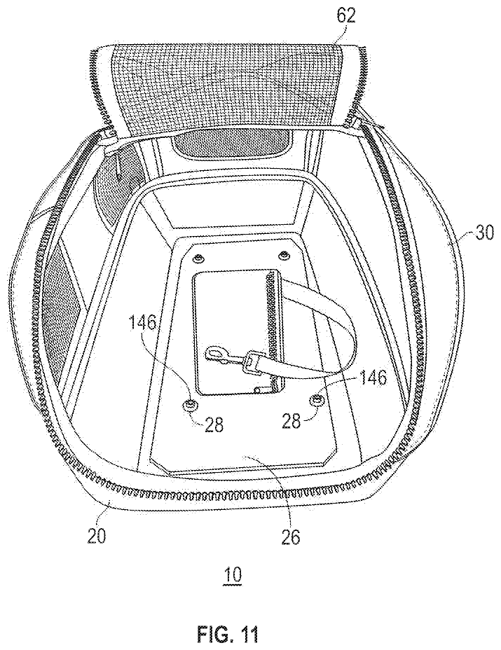

Referring to FIG. 11, the interior of the pet carrier 10 is illustratively shown in which the cushion 65 is removed to reveal four fasteners 146 from the pair of rail assemblies 140 extending through the base 20. In one embodiment, a support member 26 is provided at the bottom of the interior to provide additional support and stability to the pet carrier 10. The fasteners 146 are preferably bolts extending through the support member 26 and secured with a threaded nut 28 to retain the support member to the upper surface of the base 20, as well as each rail assembly 140 to the exterior bottom surface of the base 20. Although the fastener 146 is shown and described as being a bolt/nut pair, such fastener arrangement is not considered limiting as other fasteners can be utilized, e.g., rod/cotter pin, among other well-known fasteners 146. A person of ordinary skill in the art will appreciate that a weighted material or structure, such as a plate or other ballast material can be attached to the carrier 10, e.g., preferably to the base 20, in order to evenly distribute the weight of the carrier 10 so that the carrier maintains its upright, horizontal orientation when being transported, especially when the pet is stowed inside the carrier.

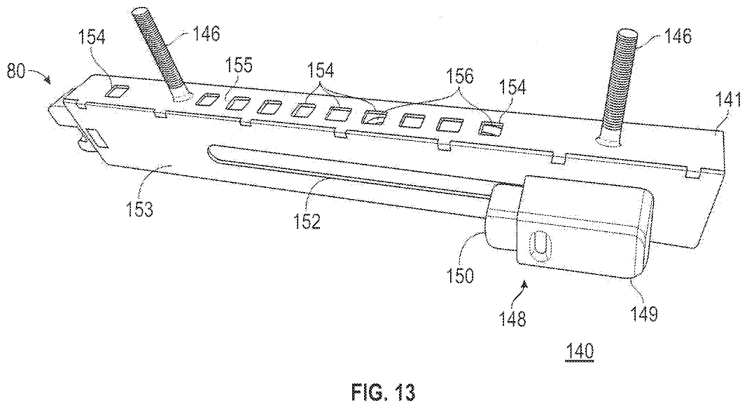

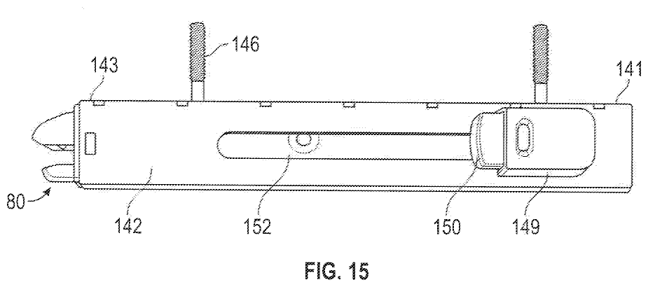

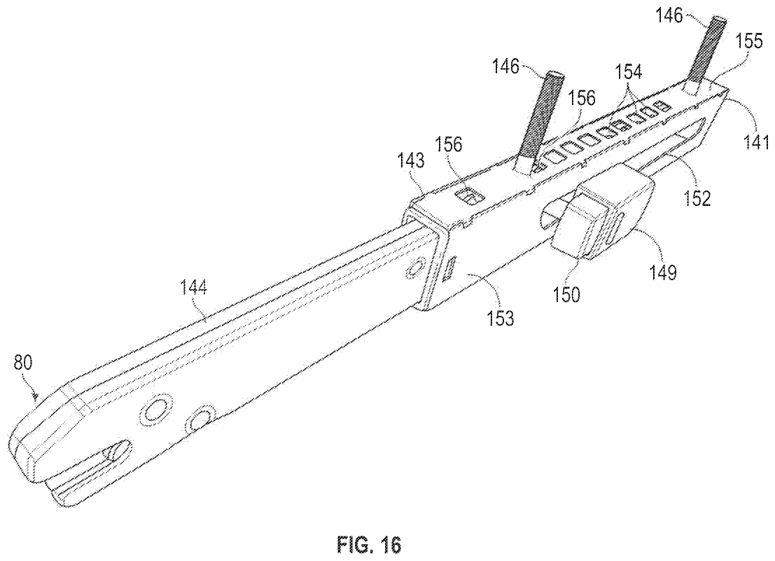

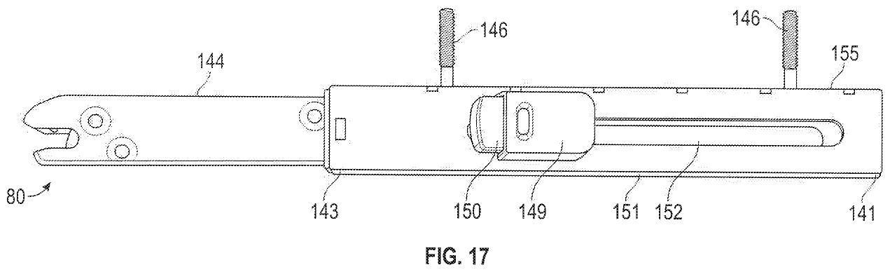

Referring now to FIGS. 13-15, a single rail assembly 140 is shown in its retracted state, and FIGS. 16-17 depict the rail assembly in its fully extended state. The outer rail 142 of the rail assembly 140 includes a proximal end 141, a distal end 143, a bottom 151, a top 155 and opposing sidewalls 153 therebetween. A slot 152 extends longitudinally through opposing sidewalls 153 of the outer rail 142. The top 155 of the outer rail 142 includes a plurality of longitudinally aligned, spaced-apart openings 154. The inner rail 144 includes the clamp 80 located at a distal end and the inner rail 144 is slidably inserted longitudinally into the outer rail 142, such that the clamp 80 extends outwardly from the outer rail 142. The inner rail 144 (with its clamp 80) is selectively movable relative to the outer rail 142 by the actuation of actuator 148, which includes a housing 149 having a rear portion extending through the longitudinal slot 152 (FIGS. 15 and 17) and fastened to the inner rail 142. The actuator 148 further includes a button or lever 150 which also has a rear end extending through the longitudinal slot 152 and attached to a latch mechanism system 156 housed within the inner rail 144. Depression of the button 150 releases the latch mechanism 156 within the inner rail.

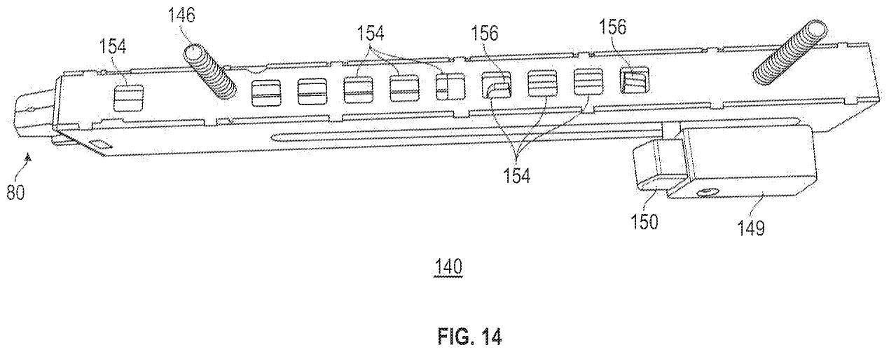

Referring to FIGS. 13 and 14, the spaced-apart openings 154 are illustratively shown in the top 155 of the outer rail 142. The rail assembly 140 illustratively includes ten longitudinally spaced-apart opening 154, although such quantity of openings 154 is not considered limiting. The rail assembly 140 is depicted in its retracted state and a first latch 156 extends through the first opening 154, which is closest to the proximal end 141 of the rail assembly 140. In addition, a second latch 156 extends through a second opening 154, which is spaced-apart from the first opening/latch combination 154/156, illustratively, by two intermediate spaced-apart openings 154, as shown in FIGS. 13 and 14. The two latches 156 of the latch mechanism prevent bi-directional movement of the inner rail 144 relative to the longitudinal axis of the outer rail 142.

When a user presses the button 150 of the actuator 148, the two latches 156 pivot in a downward direction until they no longer extend through the respective openings 154. As such, the user can push the actuator 148, which moves the inner rail 144 towards the distal end 143 of the rail assembly 140. In this manner, the clamp 80 at the end of the inner rail 144 extends a greater distance longitudinally outward from the outer rail 142. The inner rail 144 can be extended partially for fully outward with respect to the outer rail 142 and the base 20 of the carrier 10. When the user releases the button 150, the latches 156 will align and extend through an adjacent pair of openings 154, as illustratively shown in FIG. 16. In FIG. 16, the inner rail 144 is fully extended relative to the outer rail 142 and the second latch 156 extends through the most distal opening by the distal end 143. If the user presses the button 150 again, the inner rail 144 can be partially or fully retracted with respect to the outer rail 142 and the base 20 of the carrier 10.

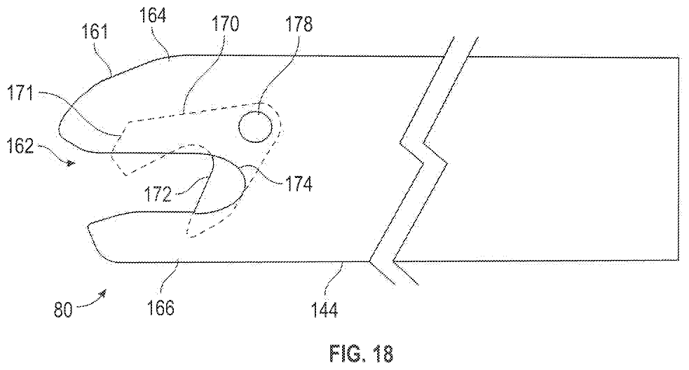

Referring to FIG. 18, the clamp 80 is shown formed at the distal end 161 of the inner rail 144. The distal end 161 of the rail includes an elongated slot 162 sized to receive the U-shaped wire seat anchor 110 of vehicle seat 210 and which divides the distal end 161 into an upper portion 164 and a lower portion 166. A latch 170 formed as a C-shaped latch is rotatably connected to the upper portion 164 by a rivet or pin 168. The C-shaped latch includes an upper jaw 171 and a lower jaw 172. When the clamp 80 is in a default state, i.e., not connected to the seat anchor 110, the upper jaw 171 of the C-shaped latch 170 is positioned upwardly within the upper portion 164 of the distal end 161 of the inner rail 144. As well, the lower jaw 172 of the C-shaped latch 170 is positioned downwardly proximate the rear end of the elongated slot 162.

During stowing and securing of the pet carrier 10 to the vehicle seat 210, the pet carrier 10 can be occupied with the pet. The pet carrier 10 is placed on the bottom seat cushion, e.g., the rear vehicle seat cushion with the clamps 80 facing rearwardly towards the vertical cushion of the seat 210. The inner rails 144 are manually extended rearwardly by pressing the button 150 and the button is released so that the inner rails 144 are locked in an extended position. The entire pet carrier 10 is moved rearwardly until the elongated slot 162 of each clamp 80 is aligned with and circumscribes the top and bottom portions of the respective wire seat anchors 110 of the vehicle seat 210. The user continues to push the base 20 of the carrier 10 so that the extended rail assembly 140 contacts the wire anchor 110, which in turn forces the lower jaw 172 of the C-shaped latch 170 to rotate towards the pet carrier, i.e., counter-clockwise in FIG. 18. The rotation of the C-shaped latch 70 causes the upper jaw 171 to pivot about the pin 168 and rotate counter-clockwise such that the leading edge of the upper jaw 171 moves downwardly to close off and block the elongated slot 162, thereby capturing the wire anchor 110 between the upper jaw 171 of the latch 170 and a rearmost portion 174 of the elongated slot 162. The latch 170 of the clamp 80 locks the pet carrier 10 to the wire anchor 110 of the seat 210. The user can again press the button 150 to slide the pet carrier rearwardly towards the seat 210 so that the outer rail 142 slides rearwardly over the inner rail 144 until the rear portion of the pet carrier 10 contacts or is proximate the vertical cushion of the vehicle seat 120. The user then releases the button 150 and the latches 156 extend through adjacent openings 154 of the outer rail 142 to lock the inner rail 144 with respect to the outer rail 142, thereby locking the pet carrier 10 in a fully secured and supported position on the seat 210 and ready for transit.

When the user wishes to remove the pet carrier 10 from the seat 120 of the vehicle, the user presses the button 150, which causes the spring-loaded, C-shaped latch 170 to automatically rotate clockwise about the pivot pin 168 and return the default position in which the elongated slot 162 of the clamp 80 is open. The user releases the button 150 to keep the rails locked in a retracted state and can then lift the pet carrier 10 off the seat 210 for transport to a new location.

In one embodiment, the clamp 80 and wire anchor 110 arrangement conforms to the LATCH (lower anchors and tethers for children) system, which is a well-known safety device and standard for use with baby carriers when transporting children in automobiles. The LATCH system is a preferable alternative to using seat belts. The lower anchors 110 of the LATCH system are rated for a maximum weight of 65 pounds, which includes the car safety seat and child. The pet carrier 10 is similarly configured to carry an occupant and can include warning labels that the total weight should not exceed the 65 pounds maximum limit under current safety standards.

With reference to the embodiment shown and described with respect to FIGS. 1-3, the clamps 80 of the LATCH system are flexibly tethered to the pet carrier 10, for example, the base 20 or rear wall 30 of the pet carrier 10. A pocket or pouch can be included along one of the walls 30, e.g., rear wall to store the free ends of the clamps 80 when not in use.

With respect to the illustrative embodiment shown and described with respect to FIGS. 4-18, the pet carrier 10 utilizes clamps 80 formed at the rear end of extendable/retractable rails 140, which are fixedly attached to the base 20 of the pet carrier 10. The rail assemblies 140 advantageously enable the pet carrier 10 to be positioned very near or snugly against the vertical cushion of the rear seat 210 of the vehicle 120, thereby preventing any deformation of the carrier walls 30 or the undesirable rocking effects which may occur with the prior art restraint systems currently used to secure the pet carrier on a rear seat of a vehicle.

Advantageously, the embodiments of the pet carrier shown and discussed herein overcomes the deficiencies of the prior art by enabling securement with the pet in the pet carrier, and in a preferred embodiment, a secure placement both on the seat and in contact with the back cushion/support of the vehicle seat.

The foregoing description of the preferred embodiment of the invention has been presented to illustrate the principles of the invention and not to limit the invention to the particular embodiment illustrated. It is intended that the scope of the invention be defined by all of the embodiments encompassed within the following claims, and their equivalents.

What is claimed:

1. A pet carrier for securing and transporting a pet in a vehicle having seat with a lower seat anchor, the pet carrier comprising:
a base;
at least one wall extending upwardly from the base;
a top forming a closed interior enclosure of the carrier;
an entryway formed in the at least one wall and/or top;
a handle secured to the carrier;
a pocket formed in one of the at least one wall and base; and
at least one clamp tethered to the carrier, wherein the at least one clamp includes a securement mechanism and a release mechanism, the at least one clamp being configured to attach and lock onto the lower seat anchor of the vehicle, and the at least one clamp is retractable or foldable to be stored in the pocket.

2. The pet carrier of claim 1, wherein the at least one clamp is tethered via a webbing to the base.

3. The pet carrier of claim 1, wherein the clamp is tethered via a webbing to the at least one wall.

4. The pet carrier of claim 1, wherein the securement mechanism of the clamp is configured to attach and lock onto the lower seat anchor of the vehicle.

5. A pet carrier for securing and transporting a pet in a vehicle having seat with a lower seat anchor, the pet carrier comprising:
a base;
a cover extending upwardly from the base;
an entryway formed through the cover;
a handle secured to the carrier; and
an extendible/retractable rail assembly fixedly attached to the base of the pet carrier, wherein the rail assembly includes a clamp at a distal rear end of the rail assembly, a securement mechanism and a release mechanism, the clamp being configured to attach and lock onto the lower seat anchor of the vehicle, and the clamp being selectively extendible from and retractable into the rail assembly to facilitate attachment and release of the pet carrier to the seat.

6. The pet carrier of claim 5, wherein the cover comprises at least one wall attached to a base and a top formed over the at least one wall.

7. The pet carrier of claim 5, wherein the cover includes a flap for selectively opening and closing the entryway.

8. The pet carrier of claim 5, wherein the handle is secured to the cover.

9. The pet carrier of claim 5, wherein the cover includes a mesh material to permit breathing within the carrier.

10. The pet carrier of claim 5, wherein the rail assembly is fixedly mounted to a bottom surface of the base.

11. The pet carrier of claim 10, wherein the rail assembly includes at least one upwardly extending fastener that extends through the bottom surface of the base.

12. The pet carrier of claim 11, wherein the upwardly extending fastener is a bolt and nut.

13. The pet carrier of claim 5, wherein the rail assembly includes an outer rail and an inner rail, the inner rail being slidably moveable within the outer rail, the clamp being formed at a distal end of the inner rail.

14. The pet carrier of claim 13, wherein the outer rail includes a longitudinal slot and an actuator is attached to the inner rail through the longitudinal slot.

15. The pet carrier of claim 14, wherein the inner rail incudes a latch and the outer rail includes a plurality of openings sized to receive the latch, wherein the actuator includes a button configured to control engagement and disengagement of the latch with the plurality of openings in the outer rail, thereby enabling slidable movement of the inner rail with respect to the outer rail.

16. The pet carrier of claim 14, wherein the actuator selectively controls opening of the clamp.

17. The pet carrier of claim 5, wherein the clamp includes an upper jaw and lower jaw configured to selectively capture and release the lower seat anchor of the seat.

18. The pet carrier of claim 5, wherein the clamp conforms to a LATCH vehicle safety standard.

19. The pet carrier of claim 5, wherein the clamp can be fully extended, partially extended or fully retracted with respect to the rail assembly.

20. The pet carrier of claim 5, in which two spaced-apart rail assemblies are attached to an exterior bottom surface of the base.
